(19) United States
(12) Patent Application Publication
(10) Pub. No.: US 2004/0254000 A1
(43) Pub. Date: Dec. 16, 2004

(54) Folding electronic device

(75) Inventor: Hsin-Liang Chen, Keelung (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/840,100

(22) Filed: May 6, 2004

(30) Foreign Application Priority Data
May 19, 2003 (TW) TW92209106

(51) Int. Cl. H04M 1/00

(52) U.S. Cl. 455/575.3

(57) ABSTRACT

A folding electronic device. The electronic device includes a body, an upper housing portion, a transmitting member, an elastic member, and a sliding member. The upper housing portion rotates between a closed position and an open position. The transmitting member rotates between a first position and a second position. The elastic member rotates the transmitting member to the second position. The sliding member rotates between a third position and a fourth position. When the sliding member is located at the third position, it is engaged with the transmitting member. When the sliding member is moved to the fourth position, it is disengaged from the transmitting member so that the upper housing portion rotates to the open position.

### BACKGROUND OF THE INVENTION

1. Field of the Invention

The invention relates to a folding electronic device, and in particular, to a folding electronic device that can be easily opened by a sliding member.

1. Description of the Related Art

Conventional handheld, folding electronic devices are opened and closed by hinge torsion. A folding mobile phone, for instance, includes an upper housing portion and a body joined by a hinge. The mobile phone may be manually opened to a predetermined angle, such as 30 degrees, relative to its closed state, by torsion acting on the hinge. The mobile phone may then be further opened automatically to a fully open angle of 180 degrees relative to its closed state.

The hinge is provided with a plurality of cams to provide the above function and fix the angle of the upper housing portion on the hinge. The device is automatically opened when the angle of the upper housing portion on the hinge exceeds a critical torsion point. For example, when the cams are designed to manually open the device to a 30 degree angle, the upper housing portion of the device can then be automatically opened to the full open angle of 180 degrees.

As stated above, before the upper housing portion of the electronic device is opened automatically to a fully open angle, it must be manually opened to a predetermined angle. Thus, it is not convenient for users.

### SUMMARY OF THE INVENTION

In view of this, the invention provides a folding electronic device that can be opened by a sliding member.

Accordingly, the invention provides a folding electronic device including a body, an upper housing portion, a transmitting member, a first elastic member, and a sliding member. The upper housing portion is disposed on the body in a manner such that the upper housing portion rotates between a closed position and an open position. The transmitting member is disposed between the body and the upper housing portion in a manner such that the transmitting member rotates between a first position and a second position. The upper housing portion rotates along with the transmitting member. The first elastic member is disposed between the transmitting member and the body so as to rotate the transmitting member to the second position. The sliding member is disposed in the body in a manner such that the sliding member rotates between a third position and a fourth position so as to rotate the transmitting member. When the sliding member is located in the third position, the sliding member is engaged with the transmitting member located in the first position. When the sliding member is moved to the fourth position from the third position, the sliding member is disengaged from the transmitting member so that the transmitting member rotates to the second position by the first elastic member and the upper housing portion rotates to the open position from the closed position.

In a preferred embodiment, the electronic device further includes a second elastic member disposed in the body so as to maintain the sliding member in the third position. The elastic force of the second elastic member exceeds that of the first elastic member. The second elastic member may be a compression spring. The body includes a first receiving portion for receiving the second elastic member. The sliding member includes a first protrusion inserted into the second elastic member so that the second elastic member returns the sliding member to the third position.

In another preferred embodiment, the body includes a first case and a second case. The first elastic member is fixed on the first case. The first case includes a second receiving portion for receiving the transmitting member and the first elastic member. Also, the first case includes a first groove in which the first elastic member is disposed. The second case is combined with the first case. The first case and the second case each includes a concave portion corresponding to the sliding member respectively so that the sliding member slides in the concave portion. The sliding member is formed with a slot corresponding to the concave portion.

In another preferred embodiment, the upper housing portion includes a second protrusion. The transmitting member includes a first notch corresponding to the second protrusion, and rotates the upper housing portion by way of the second protrusion engaging with the first notch.

In another preferred embodiment, the transmitting member includes a second notch. The sliding member includes a third protrusion, and engages with the transmitting member by the third protrusion abutting the second notch.

In another preferred embodiment, the transmitting member includes a second groove in which the first elastic member is disposed. The first elastic member is a torsional spring.

It is understood that the electronic device may be a mobile phone.

### BRIEF DESCRIPTION OF THE DRAWINGS

The present invention can be more fully understood by reading the subsequent detailed description and examples with references made to the accompanying drawings, wherein:

FIG. 1a is an exploded view of a folding electronic device as disclosed in the invention;

FIG. 1b is a perspective view of the assembled electronic device in FIG. 1a;

FIG. 2a is a schematic view of a transmitting member in FIG. 1a;

FIG. 2b is a schematic view of a combination of the transmitting member, an upper housing portion, and a first elastic member in FIG. 1a;

FIG. 2c is a schematic view of a combination of a first case and the first elastic member in FIG. 1a;

FIG. 2d is a schematic view of a combination of the sliding member, a second case, and a second elastic member in FIG. 1a; and

FIGS. 3a-3c are schematic views of the folding electronic device in FIG. 1a in various positions.

### DETAILED DESCRIPTION OF THE INVENTION

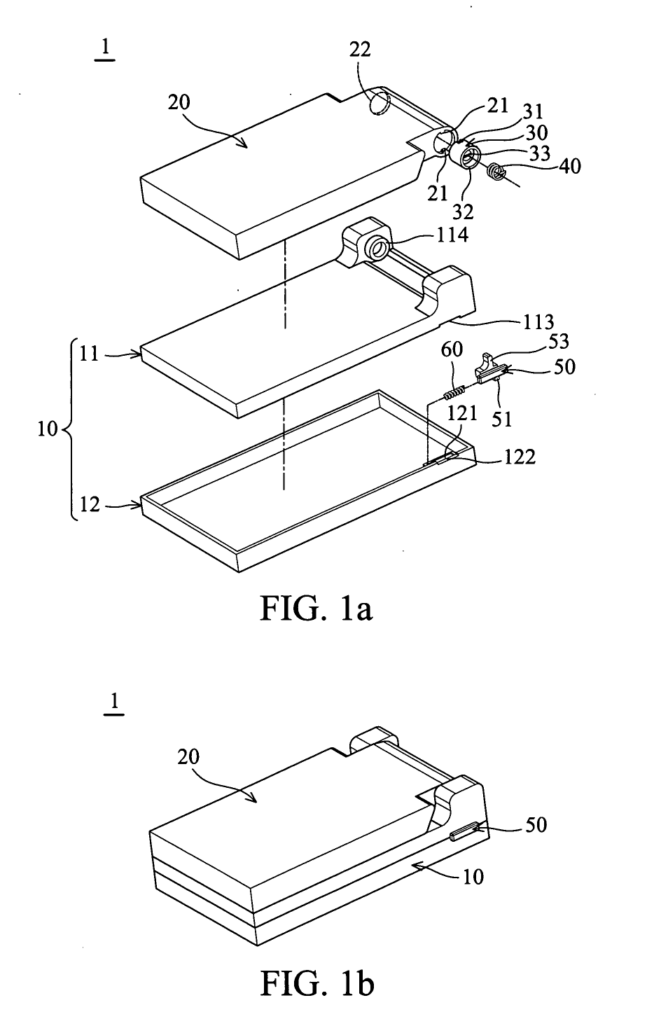

FIG. 1a-1b show a folding electronic device 1 as disclosed in the invention. The electronic device 1 includes a body 10, an upper housing portion 20, a transmitting member 30, a first elastic member 40, a sliding member 50, and a second elastic member 60.

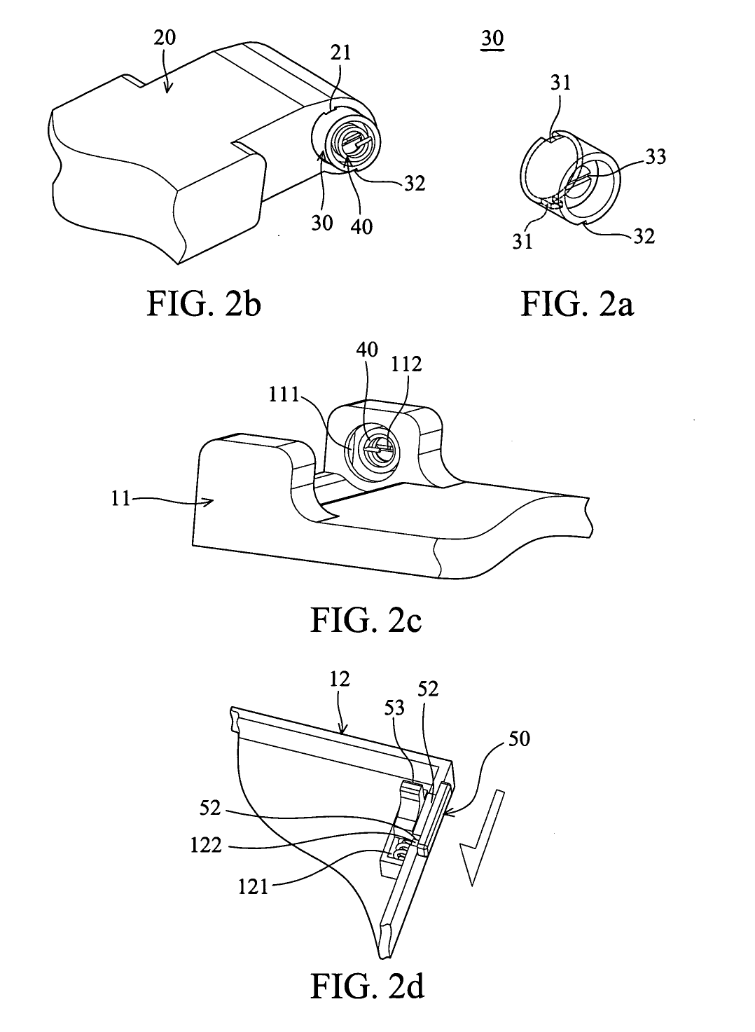

Referring to FIG. 1a, the body 10 includes a first case 11 and a second case 12. The first case 11 includes a second receiving portion 111 and a first groove 112. As shown in FIG. 2c, the second receiving portion 111 receives the transmitting member 30 and the first elastic member 40. It is noted that only the first elastic member 40 is shown in FIG. 2c. Also, the first elastic member 40 can be fixed in the second receiving portion 111 of the first case 11 by inserting into the first groove 112. Additionally, as shown in FIG. 1a, the first case 11 is formed with a rod 114 opposite to the second receiving portion 111. The upper housing portion 20 is disposed on the body 10 by the rod 114.

The second case 12 is combined with the first case 11. As shown in FIG. 2d, the second case 12 is formed with a first receiving portion 121 for receiving the second elastic member 60. The first case 11 and the second case 12 each include a concave portion 113, 122 corresponding to the sliding member 50 respectively so that the sliding member 50 slides in the concave portions 113, 122.

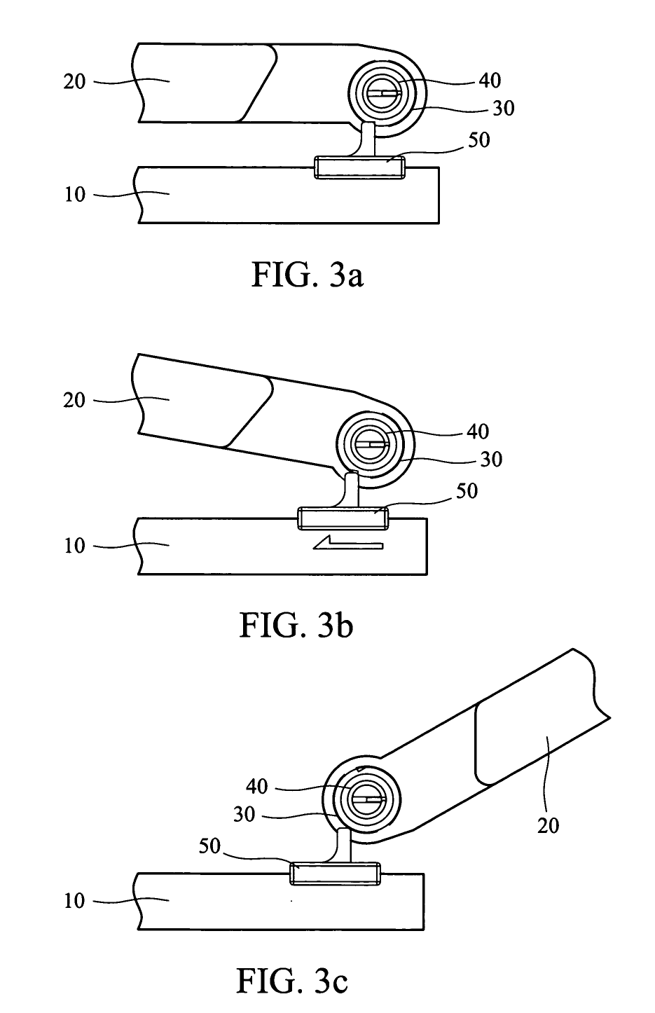

Referring to FIG. 1a, the upper housing portion 20 is disposed on the body 10 in a manner such that the upper housing portion 20 can be rotated between a closed position as shown in FIG. 3a and an open position as shown in FIG. 3c. The upper housing portion 20 includes two second protrusions 21 corresponding to the transmitting member 30. Also, the upper housing portion 20 is formed with an opening 22, corresponding to the rod 114 of the first case 11 of the body 10, opposite the second protrusions 21. Upon insertion of the rod 114 into the opening 22, the upper housing portion 20 can be smoothly rotated relative to the body 10.

As shown in FIG. 1a, the transmitting member 30 is disposed between the body 10 and the upper housing portion 20 in a manner such that the transmitting member 30 rotates between an initial position (shown in FIG. 3a and hereinafter referred as a first position) and an open position (shown in FIG. 3c and hereinafter referred as a second position). Referring to FIG. 2a, the transmitting member 30 is formed with two first notches 31, a second notch 32, and a second groove 33. Each of the first notches 31 corresponds to the second protrusion 21 of the upper housing portion 20 respectively. As shown in FIG. 2b, the transmitting portion 30 can rotate the upper housing portion 20 by way of the second protrusions 21 engaging with the first notches 31. That is, the upper housing portion 20 can be rotated along with the transmitting member 30. The second notch 32 is formed opposite the first notches 31 to engage with the sliding member 51. The second groove 33 faces the first case 11 of the body 10 to fix the first elastic member 40.

The first elastic member 40 is disposed between the transmitting member 30 and the first case 11 of the body 10 to rotate the transmitting member 30 to the second position. Specifically, one end of the first elastic member 40 is fixed in the second groove 33 of the transmitting member 30, and the other end of the first elastic member 40 is fixed in the first groove 112 of the first case 112. It is understood that the first elastic member 40 is a torsional spring.

The sliding member 50 is disposed in the body 10 in a manner such that the sliding member 50 rotates between an initial position (shown in FIG. 3a and hereinafter referred as a third position) and an open position (shown in FIG. 3c and hereinafter referred as a fourth position) so as to rotate the transmitting member 30. The sliding member 50 includes a first protrusion 51, two slots 52, and a third protrusion 53. The first protrusion 51 extends toward the second elastic member 60 and inserts into the second elastic member 60 so that the second elastic member 60 is combined with the sliding member 50. Each of the slots 52 corresponds to the concave portions 113, 121 of the first case 11 and the second case 12. Thus, by way of the slots 52 and the concave portions 113, 121, the sliding member 50 can smoothly slide in the body 10 as shown in FIG. 2d. The third protrusion 53 extends toward the transmitting member 30. The sliding member 50 engages with the transmitting member 30 by way of the third protrusion 53 abutting the second notch 32 of the transmitting member 30.

The second elastic member 60 is disposed in the first receiving portion 121 of the second case 12 of the body 10 to maintain the sliding member 50 in the third position. It is noted that the elastic force of the second elastic member 60 exceeds that of the first elastic member 40. Thus, the sliding member 50 can be maintained at the third position, and the sliding member 50 engages with the transmitting member 30 located at the first position.

It is understood that the second elastic member 60 is a compression spring. Additionally, the electronic device 1 may be a mobile phone.

The structure of the folding electronic device 1 is described above, and operation theorem thereof is as follows.

As shown in FIG. 3a, when the electronic device 1 is closed, the upper housing portion 20 is located in the closed position, the transmitting member 30 is located in the first position, and the sliding member 50 is located in the third position. At this time, since the sliding member 50 is fixed by the elastic force of the second elastic member 60, the third protrusion 53 of the sliding member 50 is engaged with the second notch 32 of the transmitting member 30. To open the upper housing portion 20, the sliding member 50 slides as shown in FIG. 3b. At this time, the transmitting member 30 rotates along with the sliding member 50. Then, when the sliding member 50 is moved to the fourth position from the third position, the third protrusion 53 of the sliding member 50 is disengaged from the second notch 32 of the transmitting member 30, releasing the first elastic member 40. Thus, the transmitting member 30 rotates to the second position, and the upper housing portion 20 rotates to the open position as shown in FIG. 3c.

To close the opened electronic device, the upper housing portion 20 is moved until the transmitting member 50 is again engaged with the sliding member 30.

As stated above, the upper housing portion can be easily opened by the sliding member on the side of the body. Compared with the conventional device, it is very convenient for the user.

While the invention has been described by way of example and in terms of the preferred embodiment, it is to be understood that the invention is not limited to the disclosed embodiment. To the contrary, it is intended to flipper various modifications and similar arrangements (as would be apparent to those skilled in the art). Therefore, the scope of the appended claims should be accorded the broadest interpretation so as to encompass all such modifications and similar arrangements.

What is claimed is:

1. A folding electronic device comprising:
a body;
an upper housing portion disposed on the body in a manner such that the upper housing portion rotates between a closed position and an open position;
a transmitting member disposed between the body and the upper housing portion in a manner such that the transmitting member rotates between a first position and a second position, wherein the upper housing portion rotates along with the transmitting member;
a first elastic member disposed between the transmitting member and the body so as to rotate the transmitting member to the second position; and
a sliding member disposed in the body in a manner such that the sliding member rotates between a third position and a fourth position so as to rotate the transmitting member, wherein the sliding member is engaged with the transmitting member located in the first position when the sliding member is located in the third position, and the sliding member is disengaged from the transmitting member so that the transmitting member rotates to the second position by the first elastic member and the upper housing portion rotates to the open position from the closed position when the sliding member is moved to the fourth position from the third position.

2. The electronic device as claimed in claim 1, further comprising:
a second elastic member disposed in the body so as to maintain the sliding member at the third position.

3. The electronic device as claimed in claim 2, wherein the elastic force of the second elastic member exceeds that of the first elastic member.

4. The electronic device as claimed in claim 2, wherein the second elastic member is a compression spring.

5. The electronic device as claimed in claim 2, wherein the body includes a first receiving portion for receiving the second elastic member.

6. The electronic device as claimed in claim 2, wherein the sliding member includes a first protrusion inserting into the second elastic member so that the second elastic member returns the sliding member to the third position.

7. The electronic device as claimed in claim 1, wherein the body comprises:
a first case on which the first elastic member is fixed; and
a second case combined with the first case.

8. The electronic device as claimed in claim 7, wherein the first case includes a second receiving portion for receiving the transmitting member and the first elastic member.

9. The electronic device as claimed in claim 7, wherein the first case includes a first groove in which the first elastic member is disposed.

10. The electronic device as claimed in claim 7, wherein each of the first case and the second case includes a concave portion corresponding to the sliding member respectively so that the sliding member slides in the concave portion.

11. The electronic device as claimed in claim 10, wherein the sliding member is formed with a slot corresponding to the concave portion.

12. The electronic device as claimed in claim 1, wherein the upper housing portion includes a second protrusion, the transmitting member includes a first notch corresponding to the second protrusion, and the transmitting member rotates the upper housing portion by way of the second protrusion engaging the first notch.

13. The electronic device as claimed in claim 1, wherein the transmitting member includes a second notch, the sliding member includes a third protrusion, and the sliding member engages with the transmitting member by way of the third protrusion abutting the second notch.

14. The electronic device as claimed in claim 1, wherein the transmitting member includes a second groove in which the first elastic member is fixed.

15. The electronic device as claimed in claim 1, wherein the first elastic member is a torsional spring.

16. The electronic device as claimed in claim 1, wherein the electronic device is a mobile phone.
